(19) United States
(12) Patent Application Publication
(10) Pub. No.: US 2023/0211351 A1
(43) Pub. Date: Jul. 6, 2023

(54) LAB-SCALE CONTINUOUS SEMI-AUTOGENOUS (SAG) GRINDING MILL

(71) Applicant: STARKEY & ASSOCIATES INC., Oakville (CA)

(72) Inventor: John STARKEY, Oakville (CA)

(21) Appl. No.: 18/008,805

(22) PCT Filed: Jun. 7, 2021
(86) PCT No.: PCT/CA2021/050779

§ 371 Date: Dec. 7, 2022

Related U.S. Application Data
(60) Provisional application No. 63/037,892, filed on Jun. 11, 2020.

(51) Int. Cl. B02C 17/18

(52) U.S. Cl. CPC B02C 17/1825; B02C 17/1855

(57) ABSTRACT

A wet continuous semi-autogenous (SAG) mill system includes a frame; a rotatable cylinder supported within the frame thereby to be rotatable about a generally horizontal rotational axis with respect to the frame, the rotatable cylinder incorporating a plurality of discharge ports about its periphery and an interior spiral blade for coaxing material within the rotatable cylinder that is downstream of the discharge ports upstream towards the discharge ports during rotation; a variable speed driving system for driving the rotatable cylinder about the rotational axis; and a SAG mill removably fastened to the rotatable cylinder upstream of the discharge ports. The SAG mill includes a grinding chamber barrel within an upstream portion of the rotatable cylinder, the grinding chamber barrel having an inside diameter of about 19.2 inches and a length of about 6.4 inches and incorporating at least one interior lifter.

### CROSS-REFERENCE TO RELATED APPLICATION

This application claims priority to U.S. Provisional Patent Application Ser. No. 63/037,892 filed on Jun. 11, 2020.

### FIELD OF THE INVENTION

The following relates generally to semi-autogenous grinding (SAG) mills, and more particularly to a lab-scale sized wet SAG mill which may run continuously on minus one inch ore as a pilot plant test SAG mill to prepare feed for mineral recovery mini-plant pilot plant testing.

### BACKGROUND OF THE INVENTION

Ore that is mined from the ground, whether in a surface mine or from underground, is obtained in a wide variety of sizes of particulate, varying from relatively small sizes to large chunks of mineralized material. The ore must be reduced to a size of particulate that is suitable for leaching or other separation of metal values from the ore in the form of naturally occurring minerals.

### SUMMARY OF THE INVENTION

In accordance with an aspect of this disclosure, there is provided a wet continuous semi-autogenous (SAG) mill system, otherwise referred to herein as a wet continuous SAG mill system, comprising: a frame; a rotatable cylinder supported within the frame thereby to be rotatable about a generally horizontal rotational axis with respect to the frame, the rotatable cylinder incorporating a plurality of discharge ports about its periphery and an interior spiral blade for coaxing material within the rotatable cylinder that is downstream of the discharge ports upstream towards the discharge ports during rotation; a variable speed driving system for driving the rotatable cylinder about the rotational axis; and a SAG mill removably fastened to the rotatable cylinder upstream of the discharge ports, the SAG mill comprising: a grinding chamber barrel within an upstream portion of the rotatable cylinder, the grinding chamber barrel having an inside diameter of about 19.2 inches and a length of about 6.4 inches, the grinding chamber barrel incorporating at least one interior lifter; a feed end diaphragm affixed to the upstream end of the grinding chamber barrel, the feed end diaphragm incorporating a central feed port dimensioned to permit crushed material to be passed into the grinding chamber barrel; and a discharge grate diaphragm removably fastened to the downstream end of the grinding chamber barrel, the discharge grate diaphragm incorporating a plurality of discharge slots each sized and positioned to permit only material that has been milled down to a predetermined size within the grinding chamber barrel to pass therethrough.

In an aspect, an upstream end of the cylinder comprises a peripheral cylinder flange against which the feed end diaphragm of the SAG mill is removably fastened.

In an aspect, a downstream end of the grinding chamber barrel comprises a peripheral barrel flange against which the discharge grate diaphragm is removably fastened.

In an aspect, the feed end diaphragm is welded to the upstream end of the grinding chamber barrel.

In an aspect, the frame is a cuboid frame.

In an aspect, the at least one interior lifter comprises a square-shaped lifter.

In an aspect, the square-shaped lifter is 1.5 inches square.

In an aspect, the at least one interior lifter comprises a plurality of rectangular lifters.

In an aspect, the SAG mill system further comprises: an inlet pipe extending through an upstream end wall of the cylinder for conveying fluid and ore into the grinding chamber barrel.

In an aspect, the discharge slots are concentrically arranged in the discharge grate diaphragm about the rotational axis.

In an aspect, the driving system comprises an electric motor and a chain associated with the outer rotating cylinder.

In an aspect, the discharge grate diaphragm further incorporates a central test port dimensioned to receive a linear measuring stick passed from outside of the cylinder via a selected one of the discharge ports thereby to measure a height of the material charge within the SAG mill.

In an aspect, the central test port is sized to permit excess material to exit the grinding chamber barrel without backing up at the feed entry port.

Other aspects and embodiments will become apparent upon reading the following description.

### BRIEF DESCRIPTION OF THE DRAWINGS

Embodiments of the invention will now be described with reference to the appended drawings in which:

FIG. 1 is a top plan view of a wet continuous semi-autogenous grinding (SAG) mill system, according to an embodiment;

FIG. 2 is a side section elevation view of the SAG mill system of FIG. 1;

FIG. 3 is a front section view of the SAG mill system of FIG. 1, taken from line E-E in FIG. 2;

FIG. 4 is a side section elevation view of a SAG mill and an upstream portion of a cylinder of the SAG mill system of FIG. 1, in isolation;

FIG. 5 is a top plan view of the SAG mill system of FIG. 1, with a top sound insulating panel in position for enclosing components of the SAG mill system within a frame;

FIG. 6 is a side elevation view of the SAG mill system of FIG. 1, with a side sound insulating panel in position for enclosing components of the SAG mill system within the frame; and

FIG. 7 is a top plan section view of the SAG mill system of FIG. 1, taken from line C-C in FIG. 6.

### DETAILED DESCRIPTION

A variety of techniques are used in the industry to effect size reduction, examples of which include crushing, rod mill and ball mill grinding, autogenous (AG) grinding and (SAG) semi-autogenous grinding or milling. In SAG milling, the ore reduced in size to about minus 200 mm in a primary crusher, is crushed and ground in a rotating mill that contains large steel balls. An autogenous mill differs from a SAG mill in that it is operated with no steel balls. The balls in SAG milling are usually steel balls. As the mill rotates, the balls are lifted by fixed lifter bars and then dropped onto the ore. The impact causes the coarse particles of ore to be crushed, cracked, and broken at the toe of the charge, or otherwise formed into smaller particulates, aided by abrasion grinding in the entire kidney shaped charge. When the particulate material reaches the required size for subsequent processing of the ore, the particulate material is removed from the SAG mill through a grate diaphragm and discharge ports. Selection of the particulate size to be discharged and removed from the system is controlled by the size of the discharge grates, and the use of screens, or other type of classifier and/or a bank of hydrocyclones. By recirculating the screen or classifier oversize back to the mill feed, the SAG mill may be operated in a substantially continuous manner.

Commercial scale SAG mills are large and process many tons of ore per hour. Requirements for a SAG mill will differ depending on the characteristics of the particular body of ore that is to be processed. Furthermore, the ore will normally not have the same characteristics throughout the deposit. For example, the hardness characteristics of the ore and the concentration of mineral and metal values are likely to vary. Some parts of the body of ore may be formed of relatively soft rock compared to other parts of the ore body. Consequently, the design of a commercial scale SAG mill needs to be optimized for efficiency in processing of a particular ore body. Thus, before a commercial scale SAG mill may be designed and constructed, it is necessary to test the milling characteristics of the ore body, which in turn requires testing of samples from different parts of the ore body. The results obtained are used in the design of the commercial scale SAG mill which, when properly designed will grind the specified tonnes per hour of ore in a continuous operation at that process feed rate. The capability to run a grinding mill at constant tonnage is required in flotation process plants because maximum recovery cannot be achieved if the feed tonnage is fluctuating.

A standard procedure in the industry has been to utilize a pilot scale SAG mill having a diameter of six feet and an effective grinding length of two feet. Such a pilot scale SAG mill is used to provide metallurgical recovery data on flow charts for processing the ground ore, and grinding characteristics such as specific energy to achieve the required fineness and product size distribution of the ground material that is representative of, and can be used in scale up, for the design of a commercial scale SAG mill. However, a pilot scale SAG mill having a diameter of about six feet processes up to about one tonne per hour of ore, and each test must be conducted for several days in order to obtain data needed for scale-up calculations. Thus, a large quantity of ore is presently required for any pilot plant grinding test. As any one sample of ore is not characteristic of the entire ore body, it is necessary to obtain and process numerous samples from the ore body, and many tons of each sample are needed. Because of this, most plants are designed and built without adequate design data, and this in turn leads to costly mistakes and production shortfalls. In fact to start up an underground mine it is prohibitively expensive to obtain a coarse sample (minus 200 mm pieces) suitable for pilot plant SAG testing and as a result only open pit mines can be properly tested prior to start-up.

One effective alternative is to utilize a laboratory SAG mill having a diameter of about 19.2 inches by 6.4 inches long, inside the chamber. A SAG mill of this size requires only a small sample of the ore, as standard diamond drill core (15 kg is needed), and that is run as a batch laboratory test, not as a continuous pilot plant test. As substantially less of each sample of ore is needed, the time and effort to obtain and provide numerous samples from the ore body, and the time to process the samples in this small SAG mill are significantly reduced. However, the small SAG mill only provides data on ore hardness, the specific gravity of the ore, and the projected energy requirements. This is sufficient data for calculation and scale up of the size of the grinding mills needed (SAG and ball mills) to a commercial size, when enough data is obtained to define the hardness variability functions for the body. However, this batch test does not provide the on-line continuous process data that is needed to validate the laboratory measurement of energy consumption, the on-line particle size distribution data that is required to accurately design the classification equipment needed to handle the circulating load stream in a full scale plant, or the metallurgical recovery response of the ground minerals that is needed to prove the financial viability of the mining and processing operation. Clients and investors require this information to reduce the risk that the process plant will not work. The batch laboratory test also does not provide enough ground material to do the downstream hydrometallurgical or pyrometallurgical pilot plant testing, which is needed to physically recover the minerals and/or metals to be sold, and to demonstrate the purity of the mineral production that will in turn, determine the value of the recovered metal in the marketplace. Meaningful pilot plant tests on SAG mill ground ore cannot thereby be obtained at reasonable cost from an underground deposit. In particular, minimal data on the grinding aspects of the operation of a commercial SAG mill is obtained. Thus, the designer of the commercial scale SAG mill and the downstream processes, is forced to make assumptions in the calculations, without actual pilot plant support data, and with no evidence on whether downstream metallurgical processes will respond in the manner predicted from the pilot plant work that does not use the proper SAG milling continuous grinding process.

In North America today, the majority if not all of the metallurgical testing by flotation, leaching, gravity and magnetic concentration, is done at a scale of about 10 to 100 kg per hour, with grinding preparation being done on finely crushed ore (minus 1.7 mm) followed by ball mill grinding of the ore to the size required to liberate the mineral values. By omitting SAG grinding of this material, the opportunity to make serious process selection mistakes is increased, especially when excess SAG generated fines consume large quantities of expensive reagents. The consequence of that is that a proposed commercial scale SAG mill has not been properly sized or evaluated, and that the process so being built, may be wrongly sized and inefficient.

Pilot plant SAG mills with diameters of approximately six-feet and effective grinding lengths of about 2 feet, have been the test SAG mills accepted and utilized in the industry for many years, especially for homogeneous ores that were found in the iron ore processing business. However, considering the heterogeneity of most copper and gold ores, a more cost-effective apparatus and method for testing the hardness of samples of an ore body, prior to the design of a commercial scale SAG mill and the following processes, has been required because of wide variability in ore hardness.

U.S. Pat. No. 6,752,338 to Starkey, the contents of which are incorporated herein by reference, disclosed a pilot plant ball mill (which is really a SAG mill), comprising a cylindrical outer chamber having flanges at opposed ends, said cylindrical outer chamber having a diameter of 2.5-5.5 feet and a ratio of length to diameter in the range of greater than 1:1. The cylindrical outer chamber contains a removable grinding chamber in the form of a sleeve, longitudinal lifters and a diaphragm, said removable grinding chamber having a ratio of diameter to length in the range of 3:1 to 1:1 and containing a plurality of steel balls not exceeding 15% of the grinding chamber volume. The removable grinding chamber extends partly down the length of the cylindrical outer chamber and has the longitudinal lifters attached to the internal surface of the sleeve, said lifters being capable of lifting steel balls and coarse pieces of ore located in the removable grinding chamber during rotation of the two cylindrical chambers. The removable grinding chamber has means at one end for receiving particulate ore from a feed hopper and said removable diaphragm at the opposed end. The removable diaphragm has outlet ports therein for discharge of ground particulate ore into the cylindrical outer chamber, said cylindrical outer chamber having discharge ports for discharge of ground particulate from the (SAG) mill, and a means to rotate the cylindrical outer chamber about a longitudinal axis. A test method using the ball (SAG) mill was also disclosed.

U.S. Pat. No. 7,197,952 to Starkey, the contents of which are incorporated herein by reference, disclosed a testing method for designing a SAG or an AG (autogenous) grinding circuit having at least one ball mill for grinding ore. The testing method comprised measuring the number of revolutions of the batch test mill for grinding a predetermined volume of ore to a first predetermined size, in a first SAG step; calculating the required grinding energy based on the measured revolutions for grinding in the first step, volume and measured specific gravity of the ore; grinding in a ball mill, in a second step, the ore from the first step to a second predetermined size; and calculating, using the Bond Mill Work Index, a required ball mill energy for the second step required to obtain a desired final grind size.

While the above-noted patents disclosed useful configurations of pilot SAG mills and useful laboratory batch tests, to address drawbacks of the prior art, improvements are desirable in order to make meaningful, reproducible and relevant pilot plant test work possible for every mining project, including both open pit and underground mineral deposits. In particular, by enabling use of standard diamond drill core for pilot plant SAG testing, the door may be opened to conduct meaningful pilot plant testing of every known mineral deposit, because standard diamond drilling is used in every mineral discovery to determine the location and grade of the valuable minerals contained in the deposit. That which is described herein may significantly upgrade the quality of newly designed grinding and mineral process recovery systems because the prior art is based on the premise that SAG pilot plant work must be done using pieces of rock at least 152 mm in size. However, it has been discovered based on an analysis of at least 15 years of laboratory testing data, that by using a batch laboratory SAG mill grinding chamber that is about 19.2 inches in diameter by about 6.4 inches long, that SAG mills up to 40 ft in diameter can be accurately designed from the laboratory test data. Since the energy used in the lab test is about 75% of the energy used when treating 152 mm feed, it is now known that good designs may be possible using 80% passing 19.05 mm feed that is readily obtained from any standard diamond drill core. It is relevant that this size of drill core is available for almost every mineral deposit in the world.

It is an object of an aspect of this disclosure to make it feasible to avoid SAG and AG mill sizing and processing mistakes and allow owners to maximize profits from their new mining operations starting from the moment the plant starts to process the ore in a SAG or AG mill.

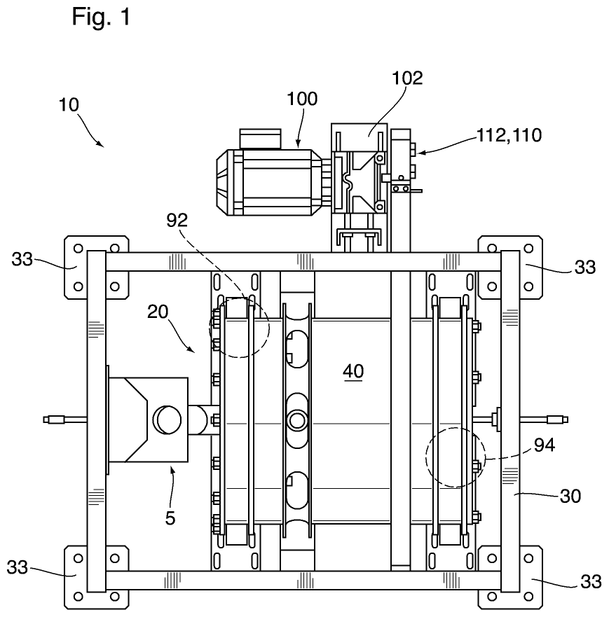

FIG. 1 is a top plan view of a wet continuous semi-autogenous grinding (SAG) mill system 10, according to an embodiment. SAG mill system 10, in this embodiment, is a wet system having features enabling it to be operated continuously. In particular, SAG mill system 10 can be operated to provide on-line continuous process data that is needed to validate the laboratory measurement of energy consumption, and on-line particle size distribution data that is required to accurately design the classification equipment needed to handle the circulating load stream in a full scale plant. Whereas systems configured only for running batch laboratory tests do not provide enough ground material to do downstream hydrometallurgical or pyrometallurgical pilot plant testing, and to demonstrate the purity of the metal production that will, in turn, determine the value of the recovered metal in the marketplace, SAG mill system 10 can be operated continuously to process sufficient material so that sufficient and accurate data can be gleaned at reasonable cost. In this description, continously, or continuous, refers to operation of a system such that it is receiving material while milling material that had already been received, so as to mill and discharge newly received material along with material that was being milled as new material was being received, thereby to process sufficient volumes of material so that the sufficient and accurate data can be obtained. This may be contrasted with batch operation wherein a quantum of material is received at one time or over a short fixed period and the quantum of material is processed and/or discharged substantially completely prior to the receiving of another quantum of material for another discrete batch and test. It will be understood that a SAG mill system as described herein being regarded as operating continuously in this manner may in fact be periodically stopped from feeding and rotating to, for example, briefly check height/levels of material within the SAG mill, before resuming feeding and rotating during a given test. Such a check may inform changes in rate of feeding of material to the SAG mill during the continuous operation.

SAG mill system 10 includes a cylindrical SAG mill 20 affixed and supported within a cylinder 40. The cylinder 40 extends longer than SAG mill 20 to provide balance and controllability to the system during rotation, and is itself supported within a cuboid frame 30 to be rotatable with respect to the frame 30 about a rotational axis R. Cuboid frame 30 includes integral legs 32. Legs 32 can, in turn, be affixed to a support surface such as a floor or a workbench using fasteners such as bolts. The bolts would pass through leg flanges 33 and into the support surface.

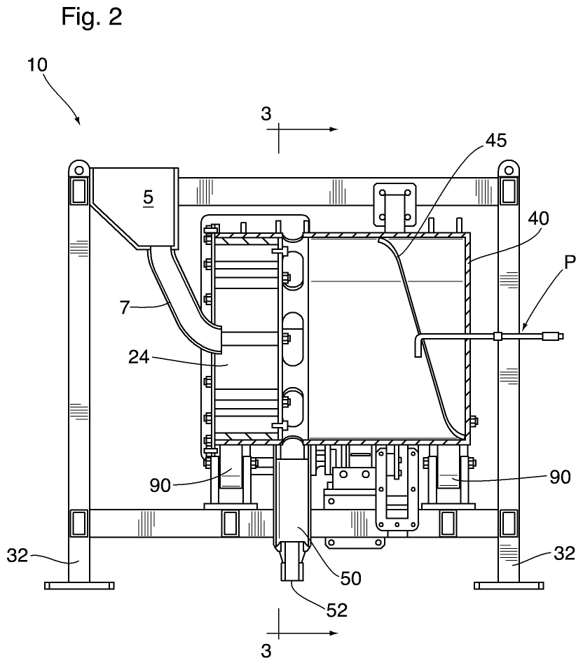

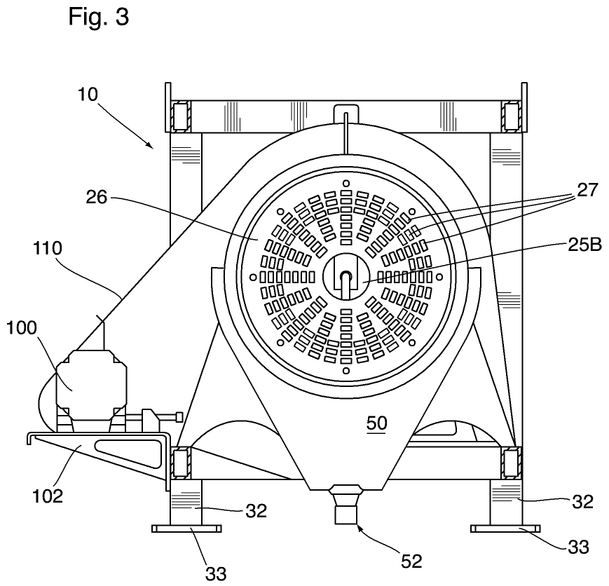

FIG. 2 is a side section elevation view of SAG mill 10 system and FIG. 3 is a front section view of SAG mill system 10, taken from line E-E in FIG. 2.

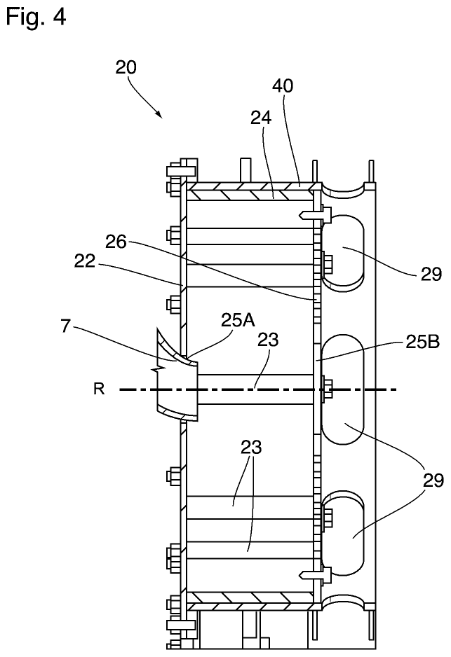

FIG. 4 is a side section elevation view of SAG mill 20 and an upstream portion of cylinder 40 of SAG mill system 10, in isolation. As can be seen particularly in FIG. 4, in this embodiment, SAG mill 20 includes a feed end diaphragm 22, a grinding chamber barrel 24 affixed to and extending from feed end diaphragm 22, and a discharge grate diaphragm 26 removably fastened to the grinding chamber barrel 24 opposite the feed end diaphragm 22. The discharge grate diaphragm 26 may be fastened by bolts or using another fastening mechanism useful for enabling removal of fasteners so that the discharge grate diaphragm 26 can be removably fastened to the grinding chamber barrel 24 as described.

In this embodiment, grinding chamber barrel 24 has an inside diameter of about 19.2 inches and a length of about 6.4 inches. In this embodiment, lifters 23 extend from the interior walls of grinding chamber barrel 24 generally inwardly, for lifting ore to be processed (not shown) as well as steel balls (not shown) for the processing.

In this embodiment, feed end diaphragm 22 is welded about its periphery to the upstream end of grinding chamber barrel 24. A circular feed port 25A extends centrally through feed end diaphragm 22 thereby to enable the feeding of crushed material from the exterior of mill chamber 20 to its interior for milling. This enables the charging of SAG mill 20 with material to be ground as well as with steel balls. In this embodiment, circular feed port 25A has a diameter of 3.5 inches and is centred on rotational axis R. During rotation of SAG mill 20 about rotational axis R, material can be fed to the interior of SAG mill 20 via circular feed port 25A. Feed end diaphragm 22 is itself bolted to an upstream flange of cylinder 40 and thereby rotates with cylinder 40, rotating the rest of SAG mill 20 along with it, during operation of SAG mill system 10. Feed end diaphragm 22 can be unbolted from cylinder 40 thus permitting removal of SAG mill 20 from within cylinder 40 for service and modifications. Other methods for removably fastening feed end diaphragm 22 to cylinder 40 are possible.

In this embodiment, discharge grate diaphragm 26 is bolted about its periphery to the downstream end of grinding chamber barrel 24. As can be seen in FIG. 3, a number of concentrically-arranged slots 27, only a few of which are identified with lead-lines in FIG. 3, extend through discharge grate diaphragm 26 thereby to enable the discharge of material from the interior of mill chamber 20 to its exterior after milling within cylindrical mill chamber 20, as will be described. Slots 27 are each sized at the maximum size of particulate to be discharged from SAG mill system 10 after milling Discharge grate diaphragm 26 otherwise blocks the discharge of larger material and blocks the discharge of the steel balls. Slots 27 are concentrically arranged so as to provide a path for exit of ground material into cylinder 40 throughout all rotational angles of cylinder 40 thereby to facilitate the continuous operation of SAG mill system 10.

Discharge grate diaphragm 26 can be unbolted from grinding chamber barrel 24 thereby to separate discharge grate diaphragm 26 from grinding chamber barrel 24. Discharge grate diaphragm 26 being removably affixed to barrel 24 enables different diaphragms, respectively with larger or smaller slots, to be associated with barrel 24. This enables a user of SAG mill system 10 to provide alternative diaphragms with larger or smaller slots 27 of this discharge grate diaphragm 26 to control the size of particulate to be discharged to its exterior after milling. It will be understood that, in order to remove or attach discharge plate diaphragm 26 from grinding chamber barrel 24, SAG mill 20 must first be removed from within cylinder 40 by unbolting feed end diaphragm 22 from the upstream end of grinding chamber barrel 24. Other methods for removably fastening discharge grate diaphragm 26 to grinding chamber barrel 24 are possible.

It has been found that maintaining the height of material within barrel 24 at or about 26% of the volume available within SAG mill 20 during pilot plant testing as consistently as possible is useful for maintaining the grinding efficiency of SAG mill system 10. For example, it will be appreciated that if there is too little material within SAG mill 20, the available grinding capacity of SAG mill 20 can be under-utilized. On the other hand, if there is too much material in SAG mill 20, the grinding capacity of the combination can drop. The grinding capacity can begin to drop after a particular volume of material is exceeded, since the extra material serves also as cushioning to break the fall of material and the steel balls, reducing the overall amount of coarse grinding that can be done with such material and steel balls. To address this, in this embodiment, a circular test port 25B, centred on rotational axis R, also extends through discharge grate diaphragm 26. Circular test port 25B is sized to enable a linear measuring stick to be passed through circular test port 25B, and thus through discharge grate diaphragm 26, to measure the height of material within SAG mill 20. In this embodiment, circular test port 25B has a diameter of 5.5 inches. It will be appreciated that circular test port 25B also allows excess material due to overfilling of SAG mill 20, to be discharged via circular test port 25B rather than cause backup within barrel 24 at the feed end where it could damage the feed pipe.

Just downstream of SAG mill 20, discharge ports 29 extend through the lateral periphery of cylinder 40. Discharge ports 29 serve to allow material being discharged from slots 27 of discharge grate diaphragm 26 into cylinder 40 to exit cylinder 40, as will be described.

In this embodiment, discharge ports 29 are uniformly distributed about the periphery of cylinder 40, and are oval-shaped with a width of 2 inches and a length of 5.5 inches. Material being discharged from SAG mill 20 via slots 27 enters cylinder 40 and, in the main, falls through discharge ports 29.

Discharge ports 29 are sized and positioned with respect to circular test port 25B to provide a linear path for a linear measuring stick to be passed from outside of cylinder 40 into circular test port 25B via one of discharge ports 29.

In this embodiment, cylinder 40 has a diameter of about 21 inches and a length of about 20 inches. Cylinder 40, being longer than SAG mill 20, is useful for stabilizing SAG mill 20 physically during operation and for providing a surface that can be engaged for driving and for rolling, as will be described.

Downstream of discharge ports 29, cylinder 40 incorporates a spiral blade 45 extending inwardly from the lateral walls of cylinder 40. As would be understood, some of the ground material that has been discharged into cylinder 40 via discharge grate diaphragm 26 may be thrown past discharge ports 29 into cylinder 40. Such material thus is not immediately discharged via discharge ports 29. It is important for measurements using SAG mill system 10 that the material being fed into SAG mill system 10 be eventually discharged completely out of SAG mill system 10. Spiral blade 45 rotates along with cylinder 40 during rotation in continuous operation thereby to continually coax any material that has be thrown downstream of discharge ports 29 back upstream towards discharge ports 29 thereby to be fully discharged. In this embodiment, an inlet pipe P extends centrally through a downstream end wall of cylinder 40 into its interior to provide a conduit through which water (or other suitable fluid) may be conveyed into cylinder 40. Inlet pipe P extends centrally—along the rotational axis R—into the downstream end wall of cylinder 40 so that cylinder 40 can rotate with respect to inlet pipe P during continuous operation, despite inlet pipe P itself remaining stationary. A trickle of added water mixes with any material downstream of discharge ports 29 to aid in the coaxing of the material within cylinder 40 back upstream towards and out of discharge ports 29.

In this embodiment, a generally V-shaped discharge hopper 50 is also supported on cuboid frame 30 and is axially aligned with discharge ports 29. Discharge hopper 50 receives discharged material exiting the discharge ports 29 about it during rotation during continuous operation. Discharge hopper 50 directs the discharged material downwards through a mill discharge passage 52 of discharge hopper 50 for conveying the discharged slurry to a vibrating screen, or other classification device, and for examination and measurement of the flow, and for the recovery and manual recirculation of the oversized material back to the SAG mill feed hopper on a regular interval of time. Mill discharge passage 52 terminates at a point above the lowermost extent of legs 32 and underlying flanges 33 thereby to enable legs 32 and flanges 33 to rest on a support surface without interference. The support surface, in turn, preferably incorporates a hole through which material exiting mill discharge passage 52 can pass for further downstream classification and recycling of the coarse oversize.

Discharge hopper 50, when viewed from the front of SAG mill 10, has “arms” that extend upwards and close to discharge ports 29 to just higher than the level of the axis of rotation R. The arms are integrated with an accumulation chamber 54 of discharge hopper 50. The inward-facing portions of arms and accumulation chamber 54 are each open-topped thereby to receive discharged material exiting discharge ports 29. As such, the arms are each generally integrated channels that receive discharged material exiting discharge ports 29 at any point along the arms. This configuration enables much of the discharged material that might be carried upwards within cylinder 40 that has not fallen straight downwards into accumulation chamber 54 after milling to, when it does exit discharge ports 29, enter into the open mouths of the arms of discharge hopper 50. This, in turn, keeps much of or all of the discharged material exiting SAG mill system 10 via mill discharge passage 52 during continuous operation. Such discharged material exiting discharge ports 29 at these higher locations is caught by the arms and guided downwards along the arms to aggregate with any material in accumulation chamber 54 and eventually to drop through mill discharge passage 52.

In this embodiment, cylinder 40 is supported on rubber rollers 90. In turn, rubber rollers 90 are supported on respective axes that are themselves supported on beams extending across the bottom of cuboid frame 30. In this manner, SAG mill 20 and cylinder 40 can rotate as a unit about rotational axis R with respect to cuboid frame 30. It will be noted that rubber rollers 90 interface with annular machined circular surface guiding tracks formed by flange pairs 92 and 94 (identified with dashed circles in FIG. 1) that are near, respectively, upstream and downstream ends of cylinder 40.

In this embodiment, rotation of cylinder 40 is achieved using an electric motor 100 driving a chain 110. Chain 110 is affixed around cylinder 40. Electric motor 100 is supported on a motor platform 102 extending from cuboid frame 30, and a chain guard 112 is supported atop chain 110 by cuboid frame 30. In this embodiment, electric motor 100 is rated at 2HP/1800 RPM/230V/3PH/60 Hz. A variable frequency drive (VFD) component (not shown) rated at 230V/3PH/60 Hz powers the electric motor 100 to enable a user to reliably and efficiently manage the velocity at which the cylinder 40 rotates and, accordingly, the speed at which SAG mill 20 rotates. As would be understood, the speed of rotation of SAG mill 20 is important in order to optimize the rate of milling along with power consumption. For example, if the speed of rotation is too high, the steel balls and other material within SAG mill 20 will tend to push outwards centrifugally with too much force. The steel balls and other material will therefore not optimally fall back down upon reaching the upper portions of SAG mill 20 to which it has been rotated. On the other hand, if the speed of rotation is too low, the steel balls and other material within SAG mill 20 will not be lifted by lifters 23 to an optimum height within SAG mill 20. The steel balls and other material will therefore not generally reach the upper portions of SAG mill 20 from which they can gain potential energy useful for when they fall back down onto material below for grinding.

In this embodiment, a feed hopper 5 and feed tube 7 are each supported on cuboid frame 30. Feed hopper 5 and feed tube 7 guide material into the interior of SAG mill 20 via circular feed port 25A of feed end diaphragm 22. Material to be ground can be put into feed hopper 5 while cylinder 40 is rotating during continuous operation, since feed tube 7, not being affixed to SAG mill 20, is stationary in relation to SAG mill 20.

In this embodiment, sound insulated panels are each removably affixed about cuboid frame 20 to enclose cylinder 40.

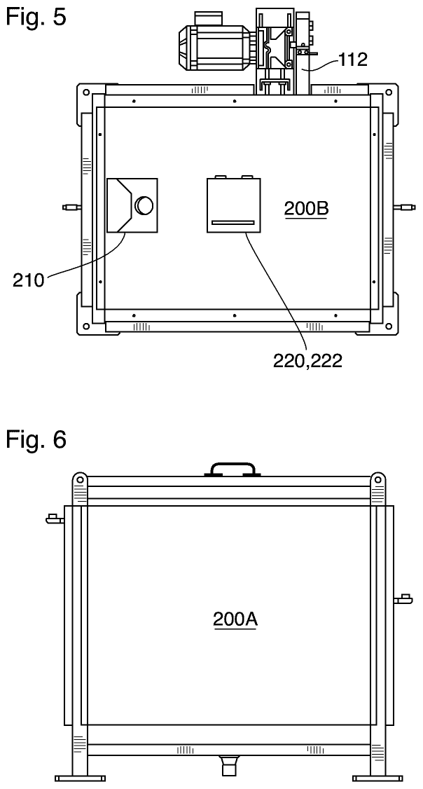

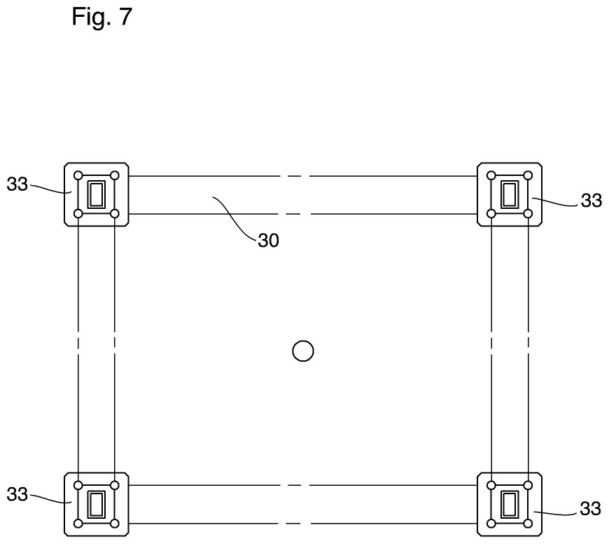

FIG. 5 is a top plan view of SAG mill system 10, with a top sound insulating panel 200B in position for enclosing components of SAG mill system 10 within frame 30. FIG. 6 is a side elevation view of SAG mill system 10, with a side sound insulating panel 200A in position for enclosing components of SAG mill system 10 within frame 30. FIG. 7 is a top plan section view of SAG mill system 10, taken from line C-C in FIG. 6.

In some embodiments, a sound insulated panel is associated with the side of cuboid frame 30 at which motor 100 and chain 110 are located. The sound insulated panel associated with the side of cuboid frame 30 is not shown in the Figures. This sound insulated panel associated with the side of cuboid frame 30 is adapted to enable chain 110 to interface with cylinder 40 and to motor 100, and to accommodate chain guard 112 extending from outside of frame 30 to interface with cylinder 40.

The sound insulated panel 200B associated with the top of SAG mill system 10 is adapted with a feed hopper port 210 that is aligned with the opening of feed hopper 5 within cuboid frame 30. This enables a user to put material into feed hopper 5 from the exterior of sound insulated panel 200B. Sound insulated panel 200B also includes an inspection port 220 with a cover 222. A handle is affixed to cover 222 for enabling a user to manipulate cover 222. Cover 222 is hingedly attached to sound insulated panel 200B for selectively covering or uncovering inspection port 220. Inspection portion 220 is axially aligned with discharge ports 29. Inspection port 220 is sized to permit a user, after stopping rotation, to pass the measuring stick through inspection port 220 and into circular test port 25B via a discharge port 29 in cylinder 40. In this way, the height of material within SAG mill 20 can be measured to confirm the amount of material inside the SAG mill.

As would be appreciated, the generation of correct commercial particle size distribution forecasts for the material recirculating, can be made from a small-scale test using SAG mill system 10. No other SAG test in the world, smaller than a 6 ft. diameter SAG mill test, can at present correctly forecast the size distributions that are required for the design of ancillary classification equipment in a new SAG mill circuit.

Although embodiments have been described with reference to the drawings, those of skill in the art will appreciate that variations and modifications may be made without departing from the spirit, scope and purpose of the invention as defined by the appended claims.

For example, while embodiments described include multiple lifters with the grinding chamber barrel, each lifter being depicted in the figures as generally rectangular extending inwardly from the walls of the grinding chamber barrel, alternatives are possible. For example, an alternative embodiment might incorporate only a single lifter of this shape, or a single lifter that is square such as a 1.5-inch square lifter.

What is claimed is:

1. A wet continuous semi-autogenous (SAG) mill system comprising:
a frame;
a rotatable cylinder supported within the frame thereby to be rotatable about a generally horizontal rotational axis with respect to the frame, the rotatable cylinder incorporating a plurality of discharge ports about its periphery and an interior spiral blade for coaxing material within the rotatable cylinder that is downstream of the discharge ports upstream towards the discharge ports during rotation;
a variable speed driving system for driving the rotatable cylinder about the generally horizontal rotational axis; and
a SAG mill removably fastened to the rotatable cylinder upstream of the discharge ports, the SAG mill comprising:
a grinding chamber barrel within an upstream portion of the rotatable cylinder, the grinding chamber barrel having an inside diameter of about 19.2 inches and a length of about 6.4 inches, wherein the grinding chamber barrel incorporates at least one interior lifter;
a feed end diaphragm affixed to an upstream end of the grinding chamber barrel, the feed end diaphragm incorporating a central feed port dimensioned to permit crushed material to be passed into the grinding chamber barrel; and
a discharge grate diaphragm removably fastened to a downstream end of the grinding chamber barrel, the discharge grate diaphragm incorporating a plurality of discharge slots each sized and positioned to permit only material that has been milled down to a predetermined size within the grinding chamber barrel to pass therethrough.

2. The wet continuous SAG mill system of claim 1, wherein the upstream end of the rotatable cylinder comprises a peripheral cylinder flange against which the feed end diaphragm of the SAG mill is removably fastened.

3. The wet continuous SAG mill system of claim 1, wherein the downstream end of the grinding chamber barrel is closed by the discharge grate diaphragm, the discharge grate diaphragm being removably fastened by bolts to the at least one interior lifter.

4. The wet continuous SAG mill system of claim 1, wherein the feed end diaphragm is welded to the upstream end of the grinding chamber barrel.

5. The wet continuous SAG mill system of claim 1, wherein the frame is a cuboid frame.

6. The wet continuous SAG mill system of claim 1, wherein the at least one interior lifter comprises a square-shaped lifter.

7. The wet continuous SAG mill system of claim 6, wherein the square-shaped lifter is 1.5 inches square.

8. The wet continuous SAG mill system of claim 1, wherein the at least one interior lifter comprises a plurality of rectangular lifters.

9. The wet continuous SAG mill system of claim 1, further comprising:
an inlet pipe extending through a downstream end wall of the rotatable cylinder for conveying fluid into the rotatable cylinder.

10. The wet continuous SAG mill system of claim 1, wherein the discharge slots are concentrically arranged in the discharge grate diaphragm about the generally horizontal rotational axis.

11. The wet continuous SAG mill system of claim 1, wherein the variable speed driving system comprises an electric motor and a chain associated with the rotatable cylinder.

12. The wet continuous SAG mill system of claim 1, wherein the discharge grate diaphragm further incorporates a central test port dimensioned to receive a linear measuring stick passed from outside of the rotatable cylinder via a selected one of the discharge ports thereby to measure a height of material within the SAG mill.

13. The wet continuous SAG mill system of claim 12, wherein the central test port is sized to permit excess material to exit the grinding chamber barrel.
